(19) United States
(12) Patent Application Publication
(10) Pub. No.: US 2026/0265072 A1
(43) Pub. Date: Sep. 10, 2026

(54) PRECIPITATION OF CRYOLITE IN THE MAX/MXENE ETCHING PROCESS - RECOVERY OF FLOUORINE AND REDUCTION OF WASTEWATER

(71) Applicant: DREXEL UNIVERSITY, Philadelphia, PA (US)

(72) Inventors: Michael S. CAREY, Philadelphia, PA (US); Michel W. BARSOUM, Moorestown, NJ (US)

(21) Appl. No.: 19/166,106

(22) PCT Filed: Mar. 22, 2024
(86) PCT No.: PCT/US2024/021097

§ 371 Date: Sep. 17, 2025

Related U.S. Application Data
(60) Provisional application No. 63/491,559, filed on Mar. 22, 2023.

(51) Int. Cl. C01F 7/54; C04B 41/53

(52) U.S. Cl. CPC C01F 7/54; C04B 41/5353

(57) ABSTRACT

A method, comprising: contacting a bicarbonate and a MXene etched by a fluorine-containing etching medium so as to provide a washed MXene.

### CROSS-REFERENCE TO RELATED APPLICATIONS

The present application claims priority to and the benefit of U.S. patent application No. 63/491,559, “Precipitation Of Cryolite In The MAX/MXene Etching Process-Recovery Of Fluorine And Reduction Of Wastewater” (filed Mar. 22, 2023). All foregoing applications are incorporated herein by reference in their entireties for any and all purposes.

### GOVERNMENT RIGHTS

This invention was made with government support under Contract No. 1740795 awarded by the National Science Foundation—DMR. The government has certain rights in the invention.

### TECHNICAL FIELD

The present disclosure relates to the field of materials science.

### BACKGROUND

In some embodiments, synthesis of MXenes includes fluorine-based etching, which etching can pose handling challenges. Accordingly, there is a long-felt need in the art for methods of recovering fluorine from MXene synthesis waste products.

### SUMMARY

Here we demonstrate the recovery of fluorine from the waste water generated in the washing procedure associated with 2D MXene synthesis through the precipitation of cryolite. Furthermore we show that by isolating the MXene sediment after etching and treating with a mild sodium bicarbonate solution, the pH of the solution may be neutralized, requiring fewer cycles of washing with deionized water, resulting in the generation of less waste in this process. Additional information is found in “Scalable and sustainable production of Ti₃C₂T_{z} MXene and Fluorine Recovery From Wastewater Through Cryolite Precipitation,” M. Carey et al., RSC Adv., 2022, 12, 30846, the entirety of which is incorporated herein by reference for all purposes. It should be understood that although the present technology is illustrated by reference to Ti₃C₂T_{z} MXenes and sodium bicarbonate, the disclosure technology is not limited to Ti₃C₂T_{z} MXene and sodium bicarbonate. Instead, it should be understood that the disclosed technology can be applied to MXenes generally and can be performed using bicarbonates other than sodium bicarbonate in some instances.

The present disclosure provides a method, comprising: contacting a bicarbonate and a MXene etched by a fluorine-containing etching medium so as to provide a washed MXene.

Also provided is a washed MXene made according to the present disclosure, e.g., according to any one of Aspects 1-6.

Also provided is a system, the system configured to perform the method according to the present disclosure, e.g., according to of any one of Aspects 1-6.

Further provided is a method, comprising: contacting a MAX-phase material with a fluorine-containing etching medium so as to form an etched MXene; contacting at least one of the etched MXene and the fluorine-containing etching medium with a bicarbonate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1A provides the structure of hexafluoroaluminic acid, and FIG. 1B provides the structure of cryolite, Na₃AlF₆.

FIG. 2 provides XRD patterns of MXene obtained by normal washing 8 times with DI (black—solid line is HF etched ML, dotted line is HCl/LiF etched delaminated films), after 1 wash with 0.05 M NaHCO₃ and 2 times with DI (red—solid line is HF etched ML, dotted line represents HCl/LiF etched delaminated films), Ti₃AlC₂ MAX phase precursor (orange), the precipitated Na₃AlH₆ (blue), and a reference profile for Na₃AlF₆ (dotted bottom red).

FIG. 3A provides an image of post-neutralization washing procedure with NaHCO₃ after washing once, and FIG. 3B provides an image of post-neutralization washing procedure with after washing twice with DI water.

FIGS. 4A-4C provide SEM micrographs of: (FIG. 4A) Ti3C2Tz film obtained after 1 wash with 40 mL 0.05 M NaHCO₃, inset is Tyndall effect of delaminated, HF-Ti₃C₂T_{z} colloidal suspension after 0.05 M NaHCO3 and H2O washing. (FIG. 4B) Multilayered HF-Ti₃C₂T_{z} powders after etching and washing with NaHCO₃, demonstrating the accordion-like structure of ML-Ti₃C₂T_{z}. (FIG. 4C) Cryolite precipitated from the spent etching liquid, inset in FIG. 4C is a picture of obtained cryolite.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Here we demonstrate the recovery of fluorine from the waste water generated in the washing procedure associated with 2D MXene synthesis through the precipitation of cryolite. Furthermore we show that by isolating the MXene sediment after etching and treating with a mild sodium bicarbonate solution, the pH of the solution may be neutralized, requiring fewer cycles of washing with deionized water, resulting in the generation of less waste in this process.

At the current stage of development, the precipitation of cryolite has been demonstrated when Ti3 AlC2 MAX phase was first etched with 10% hydrofluoric acid (HF) at room temperature (RT) for 24 h. After the sediment is separated from the liquid, a 3M Na2CO3 solution was added to the spent/discarded liquid until a pH of 4.0. This solution is then heated at 55 C for 1 h, allowed to cool and filtered, where cryolite was obtained. Direct precipitation of cryolite in the HCl/LiF system is underway, and the presence of cryolite has been detected by XRD in sediments of bicarbonate washed Ti3C2 MXene which were made by the HCl/LiF method.

The precipitation of cryolite in this process allows for: 1) the recovery of fluorine from the waste stream, 2) the production of an added-value product, as cryolite is used extensively in the production of aluminum and; 3) an analytical tool to calculate the efficiency of Al extraction from MAX through the gravimetric quantification of the precipitated cryolite, which may in turn allow for the optimization of parameters governing MXene production, such as etching time, temperature, pH and reactant concentrations.

MXene sediment which was treated with a bicarbonate solution and subsequently washed with deionized water was obtained with 160 mL per gram of Ti3C2, which is much lower than the volume 600-800 mL typically required by deionized water washing only.

Traditional synthesis of Ti₃C₂ MXene, most commonly obtained by the selective etching of Al from Ti₃AlC₂ MAX phase with hydrofluoric acid, HF, requires a large amount of water to obtain a colloidal suspension of few to single flake Ti₃C₂.^{1,2} Typically, the amount of water needed is about 640-800 mL per gram of MXene as this volume is thought to both wash away residual salts formed in the etching process, and to bring the solution pH to neutral at which point a stable colloidal MXene suspension forms. Herein we show that by modifications made to the synthesis process, we can obtain Ti₃C₂ colloidal suspensions with much less water utilized in the washing procedure. The fluorine in the remaining wastewater can also be recovered through the precipitation of cryolite.

While MXenes have been shown to be quite promising in terms of their performance across a wide variety of applications, their widescale production has lagged.³⁻⁵ One of the limiting steps at this time is the large cost of their production and the need for fluorine in the etching medium. Additionally, the treatment of HF containing wastewater is both a major industrial and environmental concern.⁶

For MXene production to occur at industrial scales, the large amount of acidic wastewater that is currently a byproduct of its methods of production must be addressed. Furthermore, the presence of F⁻ in this wastewater is problematic as this treatment is quite costly and produces a large amount of industrial waste sludge that becomes difficult to dispose of due to environmental regulations.⁷ It is believed that the main product of the selective etching of Al from Ti₃AlC₂ to yield Ti₃C₂ is AlF₃,⁸ which has limited solubility in water (0.5 g/100 g H₂O at 25° C.).⁹

The MAX phase is known to form a protective oxide layer which is composed of Al₂O₃ and TiO₂.¹⁰ A product of the reaction between Al-containing species such as alumina and HF is hexafluoroaluminic acid (H₃AlF₆).^{11,12} If H₃ AlF₆ is present, then a route to recovering fluorine from the wastewater exists through the addition of sodium cations to form sodium hexafluoroaluminate, otherwise known as cryolite, which can be readily isolated from the spent etching liquid.^{11,12} In the reaction of the Al in Ti₃AlC₂ with HF, a route for the formation of hexafluoroaluminic acid and cryolite may be as follows:

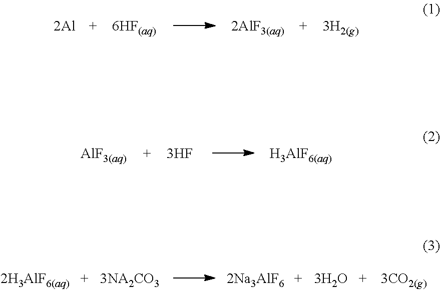

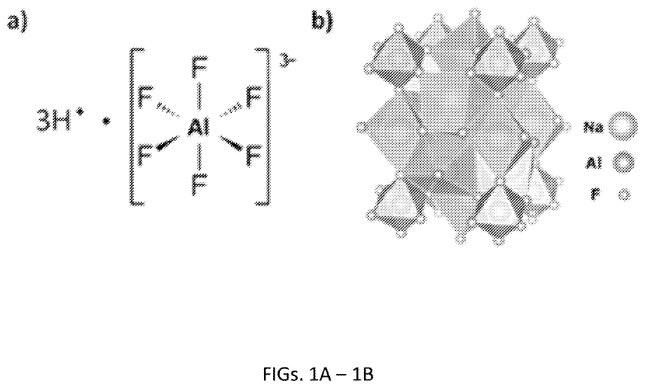

With the typical etching procedure² there is enough HF to fully convert AlF₃ to H₃AlF₆. Furthermore, AlF₆ is believed to be a stable species as the ionic strength of the solution increases.^{13,14} In this reaction, the formation of H₃AlF₆ may provide a driving force for the continued extraction of Al from Ti₃AlC₂, potentially explaining why HF is the only acid capable of etching the MAX phase to yield MXenes.^{3,15} The structures of hexafluoroaluminic acid and cryolite are shown in FIG. 1.

Sodium hexafluoroaluminate, Na₃AlF₆, more commonly known as cryolite, is insoluble in water, but soluble in sulfuric acid, H₂SO4, with the evolution of HF. Synthetic cryolite finds widespread industrial use as a flux agent to dissolve alumina, Al₂O₃, in the electrolytic metal extraction process. It is also consumed in the abrasives, ceramic and glass industries.^{12,16} Many research articles and patents have appeared over the years regarding the production of cryolite, suggesting that if cryolite can be isolated and repackaged as a by-product of MXene production, the economics associated with the scale-up of MXene synthesis may be partially offset. By our calculations, assuming complete etching of Al from Ti₃AlC₂ and complete conversion to cryolite, 1.07 g may be produced from 1 g of Ti₃AlC₂. This may be an attractive method to lower the cost of wastewater treatment and produce a high purity, high value compound, while also providing a quantitative tool for the determination of etching efficiency. The feasibility of this method is supported by the work of Kumar et al. which showed that the recovery of synthetic cryolite from the neutralization of synthetic HCl/HF leach liquors comprising H₃SiF₆ and H₃AlF₆ with 3 M Na₂CO₃ was 97.5%.¹²

In this work we demonstrate that by washing the acidified MXene sediment once with a mild solution of low-cost and environmentally benign, NaHCO₃, colloidal suspensions can be produced using much less deionized water than otherwise is needed. By similarly treating the waste etching liquid with 3M Na₂CO₃, cryolite can be formed and precipitated, providing a useful method for the determination of Al extraction efficiency.

The experimental approach in this work is largely separated into two segments which are focused on: 1) neutralization of the MXene sediment to obtain Ti₃C₂ with less water, and 2) precipitation of cryolite from the spent etching waste. This split occurs after the etching period, when the MXene sediment is isolated from the etching liquid. This is done through centrifugation. However it is not limited to this methodology—any filtration method would be sufficient. We will focus first on the MXene sediment and its neutralization with low-cost sodium bicarbonate. After separation, the sediment in each centrifuge tube was treated with 3.5 mL of 1M NaHCO₃ so that the pH was adjusted to 7.0.

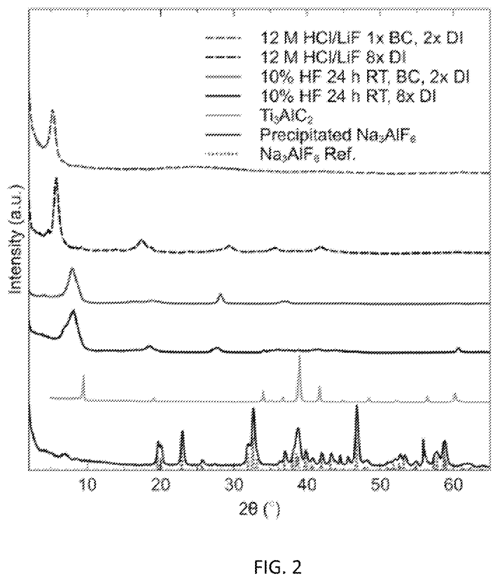

The sediments produced by this method were first investigated by XRD to ensure that etching of the MAX phase was complete, and to characterize the obtained MXene. In FIG. 2, XRD patterns of MXene obtained by normal washing (middle, black), MXene after 1 wash with 3.5 mL 1M NaHCO₃, (top, red) and the precipitated Na₃AlF₆ from the spent etching liquid. A Reference profile for Na₃ AlF₆, is also presented.

It is evident from these patterns that the MXene obtained by the neutralization method is the same as the MXene obtained by the normal washing method. In fact, the HF-etched ML MXene pattern obtained after BC and DI washing appears to be cleaner than the water only washed sample, as many peaks associated with Ti3AlC2 in the range of _35-45_2q are still present in that sample. Interestingly, the 110 peak present at _61_2q is not present in the BC washed specimen, suggesting that there is a complete absence of non-basal ordering in this sample. Furthermore, the HCl/LiF, BC washed film does not display the same number of 001 reflections as the HCl/LiF, DI washed film.

The cryolite precipitated from the waste etching liquid matches nearly perfectly to the reference pattern (bottom red dotted lines in FIG. 2). The amount of cryolite was measured to be 0.89 g, indicating an etching efficiency of 84%. We believe that this method can prove to be an effective tool for optimizing the etching efficiency, and this value can be pushed closer to 100% by variations in etching conditions such as time, pH of solution, temperature, or reagent concentrations.

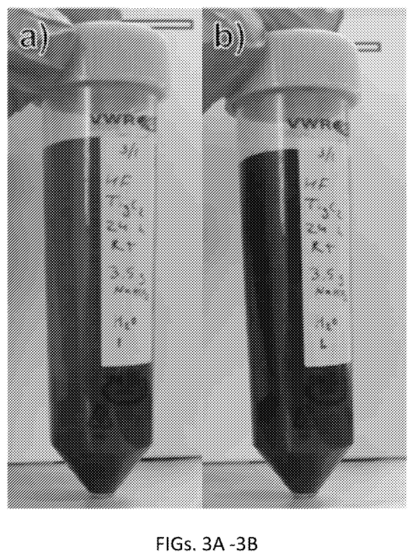

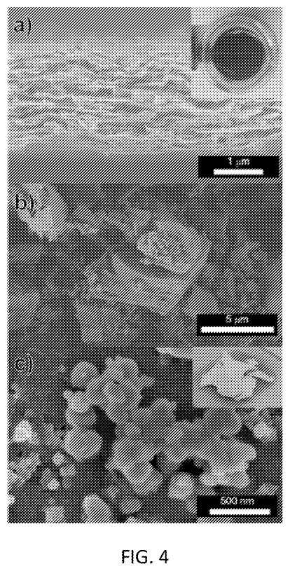

Complete washing of Ti3C2Tz MXene (indicated by a near neutral pH and stable supernatant after centrifugation) requires between 8 and 10 washing cycles when only washing with only DI H2O. However after treatment with 0.05 MNaHCO3 (regardless of HF or HCl/LiF etching method), this stability occurred within two rounds of washing, as seen in FIG. 3. Interestingly, a stable suspension is found after just the first wash (FIG. 3a). However in our washing procedure, an additional wash step was carried out that resulted in a darker, more concentrated suspension (FIG. 3b). Washing with DI H2O only, required 640 mL. However with the incorporation of one 40 mL 0.05 M NaHCO3 wash before subsequent DI washes, the volume of water necessary to produce a dark colloidal suspension was 160 mL per gram of Ti3C2Tz sediment. An SEM micrograph of the Ti3C2Tz filtered film after exposure to NaHCO₃ can be seen in FIGS. 4a and b along with an SEM micrograph of the obtained Na3 AlF6 in FIG. 4c. Typically, Ti3C2Tz produced by etching with HF, only do not yield delaminated flakes (referred to as d-Ti3C2Tz, to insinuate delamination) without the use of a chemical exfoliation agent such as TBAOH or DMSO.5,20-22 However, with our approach, a colloidal suspension was obtained after NaHCO3 and DI water washing, and a film of d-Ti3C2Tz was produced by vacuum filtration of this suspension (FIG. 4a). A photograph of this colloidal suspension, and the Tyndall effect produced by the d-Ti3C2Tz flakes, is shown as an inset of FIG. 4a. Conductivity measurements were conducted on this film with a four-point probe, and a DC conductivity of 180_10 S cm-1 was measured.

A film was attempted to be produced by the DMSO assisted intercalation and delamination of HF etched, water only washed, Ti3C2Tz, however the concentration of this suspension was so slow that a continuous film m was unable to be obtained.

Conductivity measurements were attempted on a section of this film, and a value of 2.25+/−0.05 S cm-1 was measured.

Conductivity measurements were similarly conducted on HCl/LiF etched films, one washed first with 0.05 M NaHCO₃, and the other washed only with water. In the BC washed case, the colloidal suspension had a concentration of 18 mg mL-1 and a film produced from this suspension had conductivity of 1150+/−27 S cm-1 was measured, while the H2O washed colloidal suspension had a concentration of 15.6 mg mL-1 and the corresponding film had a conductivity of 1330+/−54 S cm-1. These are comparable to the conductivity of Ti3C2Tz clay reported by Ghidiu et al.²

In summary, a simple yet effective method of obtaining Ti3C2Tz MXene is presented where the isolated etched sediment is neutralized with a mild solution of sodium bicarbonate. In so doing, the pH can directly be adjusted to neutral without the need of large volumes of DI water. This drastically reduces the amount of wastewater generated, specifically from 640 mL g-1 to 160 mL g-1, a reduction of 75%. This holds for both HF only and HCl/LiF etched Ti3C2Tz. Furthermore, when etched with HF, delaminated films of Ti3C2T_{z} could be produced, provided they were treated with 0.05 M NaHCO₃ before washing with deionized water. Furthermore, films produced by etching with HCl/LiF and then washed once with 0.05 M NaHCO₃, followed by two washes with deionized water resulted in a colloidal suspension with a concentration of 18 mg mL-1 Filtered films made from this suspension had a conductivity of 1,150_27 S cm-1. Additionally, cryolite (Na₃AlF6) can be formed from this process, which indicates that the etching media used for the extraction of Al from Ti3 AlC2 must contain hexafluoroaluminic acid, H3AlF6. This provides insight into the chemistry of the etching reaction and allows for the recovery of fluorine from the spent etching liquid. The cryolite obtained from this neutralization can be precipitated by treatment with sodium carbonate, further offsetting the cost of MXene production, and providing a quantitative tool for calculating etching efficiency which would allow for the optimization of the etching parameters such as time, temperature, pH and reagent concentrations.

### Materials and Methods

The experimental approach in this work is largely separated into two segments which are focused on: (1) neutralization of the MXene sediment to obtain high quality Ti3C2Tz MLs with less water, and (2) precipitation of cryolite from the spent etching waste.

Two etching methods are explored in this work. Namely, the use of HF acid only as well as the method first reported by Ghidiu et al. utilizing hydrochloric acid and lithium fluoride to produce HF in situ.2 The latter method is more widely adopted due to the improved handling safety and ability to directly yield delaminated suspensions. However, when considering the precipitation of cryolite through neutralization of the spent etching liquid, the HF only method is a much cleaner system, as there are fewer ionic species present. For the purposes of this work, we demonstrate that cryolite, Na3AlF6, can be precipitated from the spent etching media obtained from the HF-only method.

The neutralization of the MXene sediment with 40 mL 0.05 M NaHCO₃ is applicable to both methods of MXene production. Given that the HCl/LiF method is more widely adopted by those that work with MXene, we felt it was important to demonstrate the effectiveness of this washing procedure when working with HCl/LiF etched MXene.

### HF Etching of Ti3 AlC2 to Produce HF-Ti3C2Tz

MXene etched by HF acid only, (henceforth referred to as HF-Ti3C2Tz) was obtained by etching 1 g of Ti3AlC2 MAX phase in 10 mL of 10% HF for 24 h at RT.

### Sodium Bicarbonate Washing of HF-Ti3C2Tz

After the etching period, the HF-Ti3C2Tz ML sediment is isolated from the etching liquid through centrifugation. The spent liquid portion is set aside and used for cryolite precipitation.

After separation, the sediment in each centrifuge tube (0.5 g per tube) was treated with 40 mL of 0.05 M NaHCO3 so that the pH was adjusted to 7.0. A er the initial wash with 0.05 M NaHCO3, the sediment was washed two times with 40 mL of DI water.

### Delamination of NaHCO₃Washed HF-Ti3C2Tz

20 mL of DI water was added to the sediment obtained after washing with 0.05 M NaHCO3 and DI water, which was then bath sonicated for 1 h under argon flow. After sonication, the colloidal suspension was isolated by centrifugation at 5000 rpm for 10 minutes. This suspension was then filtered to obtain a film.

### HF-Etched, H2O Washed Ti3C2Tz

For comparison to the NaHCO₃ method, a separate 1 g batch of HF-Ti3C2Tz was washed only with DI water. To produce a film of the HF-Ti3C2Tz washed only with water, 12 mL of dimethyl sulfoxide (DMSO) was added to the washed sediment and allowed to mix for 24 h at room temperature (RT). After mixing, the DMSO was separated by centrifugation at 3500 rpm for 5 minutes. 20 mL of DI H2O was added to the DMSO intercalated sediment, and bath sonicated for 1 h under flowing argon. After sonication, the colloidal suspension was isolated by centrifugation at 5000 rpm for 10 minutes. This suspension was then filtered to obtain a film.

Precipitation of Cryolite from HF-Ti3C2Tz Etching Media

Cryolite was precipitated by adding 3 M Na₂CO3 to the isolated etching liquid until a pH of 4.0. This solution was then kept in a 55 deg. C. oil bath for 1 h, after which the gelatinous liquid was vacuum filtered over a Celgard polypropylene membrane where a white crystalline solid was formed.

### HCl/LiF-etched Ti3C2Tz

To demonstrate the applicability of this method to the more widely used method first reported by Ghidiu et al.,² two grams of Ti3C2Tz were prepared by etching two grams of Ti3AlC2 in 20 mL of 12 M HCl along with two grams of lithium fluoride. This mixture was allowed to mix at 35 deg. C. for 48 h at 300 rpm. After etching, the contents of the etching bottle were split equally into four centrifuge tubes so that 0.5 g of sediment was in each centrifuge tube. Two of the tubes were washed only with deionized water, while the other two were first washed with 40 mL of 0.05 M NaHCO3, followed by two washes with deionized water.

After the washing period, the contents of the tubes were combined so that roughly 1 g of each separately washed powders of Ti3C2Tz were in each tube. 20 mL of DI H2O was added to each tube, and these mixtures were bath sonicated for 1 h under flowing argon. After sonication, the colloidal suspensions were collected by centrifugation at 5000 rpm for 10 minutes. These colloidal suspensions were filtered into films by filtration.

### ASPECTS

The following Aspects are illustrative only and do not limit the scope of the present disclosure or the appended claims. Any part or parts of any one or more Aspects can be combined with any part or parts of any one or more other Aspects.

Aspect 1. A method, comprising: contacting a bicarbonate and a MXene etched by a fluorine-containing etching medium so as to provide a washed MXene.

Aspect 2. The method of Aspect 1, further comprising separating the washed MXene from the etching medium.

Aspect 3. The method of Aspect 2, further comprising contacting the etching medium and a bicarbonate.

Aspect 4. The method of Aspect 3, further comprising precipitating cryolite.

Aspect 5. The method of Aspect 1, further comprising delaminating the washed MXene.

Aspect 6. The method of any one of Aspects 1-5, wherein the bicarbonate is sodium bicarbonate.

Aspect 7. A washed MXene made according to any one of Aspects 1-6.

Aspect 8. A system, the system configured to perform the method of any one of Aspects 1-6.

Aspect 9. A method, comprising: contacting a MAX-phase material with a fluorine-containing etching medium so as to form an etched MXene; contacting at least one of the etched MXene and the fluorine-containing etching medium with a bicarbonate.

Aspect 10. The method of Aspect 9, further comprising cryolite from fluorine-containing etching medium contacted with the bicarbonate.

### REFERENCES

1. M. W. Barsoum, MAX phases: properties of machinable ternary carbides and nitrides, John Wiley & Sons, 2013.
2. M. Naguib, M. Kurtoglu, V. Presser, J. Lu, J. Niu, M. Heon, L. Hultman, Y. Gogotsi and M. W. Barsoum, Adv. Mater., 2011, 23, 4248-4253.
3. M. Ghidiu, M. R. Lukatskaya, M.-Q. Zhao, Y. Gogotsi and M. W. Barsoum, Nature, 2014, 516, 78-81.
4. L. Verger, V. Natu, M. Ghidiu and M. W. Barsoum, J. Phys. Chem. C, 2019, 123, 20044-20050.
5. L. Verger, V. Natu, M. Carey and M. W. Barsoum, Trends Chem, 2019, 1, 656-669.
6. L. Verger, C. Xu, V. Natu, H. Cheng, W. Ren and M. W. Barsoum, Curr. Opin. Solid State Mater. Sci., 2019, 1-15.
7. M. Naguib, V. N. Mochalin, M. W. Barsoum and Y. Gogotsi, Adv. Mater., 2014, 26, 992-1005.
8. C. H. Won, J. Choi and J. Chung, J. Hazard. Mater., 2012, 239-240, 110-117.
9. A. Toyoda and T. Taira, IEEE Trans. Semicond. Manuf., 2000, 13, 305-309.
10. O. Mashtalir, M. Naguib, B. Dyatkin, Y. Gogotsi and M. W. Barsoum, Mater. Chem. Phys., 2013, 139, 147-152.
11. D. R. Lide, CRC Handbook of Chemistry and Physics, CRC press, 2004, vol. 85.
12. C. B. Cockreham, X. Zhang, H. Li, E. Hammond-Pereira, J. Sun, S. R. Saunders, Y. Wang, H. Xu and D. Wu, ACS Appl. Energy Mater., 2019, 2, 8145-8152.
13. M. W. Barsoum, N. Tzenov, A. Procopio and M. Ali, J. Electrochem. Soc., 2001, 148, 551-562.
14. V. S'cepanovi'c, S. Radosavljevi'c and J. Misovi'c, J. Fluor. Chem., 1974, 3, 403-408.
15. M. Kumar, M. N. Babu, T. R. Mankhand and B. D. Pandey, Hydrometallurgy, 2010, 104, 304-307.
16. M. Naguib, M. Kurtoglu, V. Presser, J. Lu, J. Niu, M. Heon, L. Hultman, Y. Gogotsi and M. W. Barsoum, Adv. Mater., 2011, 23, 4248-4253.
17. M. S. Corbillon, M. A. Olazabal and J. M. Madariaga, J. Solution Chem., 2008, 37, 567-579.
18. V. D. Jovic, B. M. Jovic, S. Gupta and T. El-raghy, Corr. Sci., 2006, 48, 4274-4282.
19. Z. Akdeniz and M. P. Tosi, Chem. Phys. Lett., 1999, 308, 479-485.
20. O. Mashtalir, M. Naguib, V. N. Mochalin, Y. Dall′ Agnese, M. Heon, M. W. Barsoum and Y. Gogotsi, Nat. Commun., 2013, 4, 1716.
21. J. Halim, S. Kota, M. R. Lukatskaya, M. Naguib, M. Zhao, E. J. Moon, J. Pitock, J. Nanda, S. J. May, Y. Gogotsi and M. W. Barsoum, Adv. Funct. Mater., 2016, 26, 3118-3127.
22. P. Urbankowski, B. Ansori, T. Makaryan, D. Er, S. Kota, P. L. Walsh, M. Zhao, V. B. Shenoy, M. W. Barsoum and Y. Gogotsi, Nanoscale, 2016, 8, 11385-11391.

What is claimed:

1. A method, comprising:
contacting a bicarbonate and a MXene etched by a fluorine-containing etching medium so as to provide a washed MXene.

2. The method of claim 1, further comprising separating the washed MXene from the etching medium.

3. The method of claim 2, further comprising contacting the etching medium and a bicarbonate.

4. The method of claim 3, further comprising precipitating cryolite.

5. The method of claim 1, further comprising delaminating the washed MXene.

6. The method of claim 1, wherein the bicarbonate is sodium bicarbonate.

7. A washed MXene made according to claim 1.

8. A system, the system configured to perform the method of claim 1.

9. A method, comprising:
contacting a MAX-phase material with a fluorine-containing etching medium so as to form an etched MXene;
contacting at least one of the etched MXene and the fluorine-containing etching medium with a bicarbonate.

10. The method of claim 9, further comprising cryolite from fluorine-containing etching medium contacted with the bicarbonate.
